(19) United States
(12) Patent Application Publication
(10) Pub. No.: US 2025/0351029 A1
(43) Pub. Date: Nov. 13, 2025

(54) DETERMINATION METHOD OF HANDOVER MECHANISM AND DETERMINATION SYSTEM OF HANDOVER MECHANISM

(71) Applicant: LUXSHARE PRECISION INDUSTRY COMPANY LIMITED, Baoan Shenzhen (CN)

(72) Inventors: Guan Hsiung WANG, Baoan Shenzhen (CN); Wei Hsin CHEN, Baoan Shenzhen (CN)

(21) Appl. No.: 18/890,057

(22) Filed: Sep. 19, 2024

(30) Foreign Application Priority Data
May 8, 2024 (CN) 2024105645603

(51) Int. Cl. H04W 36/00; H04B 17/309; H04B 17/318

(52) U.S. Cl. CPC H04W 36/00833; H04B 17/328; H04B 17/346

(57) ABSTRACT

A determination method of a handover mechanism and a determination system of a handover mechanism are provided and are used in a plurality of base stations within a 5G NR network. There is a mobile communication device within the signal common coverage scope of the plurality of base stations. By the determination method of the handover mechanism and the determination system of a handover mechanism, the mobile communication device is switched to have a communication connection with a target base station after the signal strength between the mobile communication device and each base station is ensured to reduce the generation of ping-pong effects.

### CROSS-REFERENCE TO RELATED APPLICATIONS

This application claims the priority benefit of Chinese Patent Application Serial Number 2024105645603, filed on May 8, 2024, the full disclosure of which is incorporated herein by reference.

### TECHNICAL FIELD OF THE INVENTION

The present disclosure is related to a determination method of a handover mechanism and a determination system of a handover mechanism and is particularly related to the determination method of the handover mechanism and the determination system of the handover mechanism to reduce the ping-pong effects.

### DESCRIPTION OF THE PRIOR ART

As the advance of technologies, the structures of current mobile communication networks continuously progress. At present, a 5G NR (new radio) system has been developed and can completely cover the spectrums of millimeter wave (mm Wave) frequency bands from 30GHz to 300GHz by the new global 5G standards based on orthogonal frequency division multiplexing (OFDM) technologies. However, because the 5G NR system operates in the higher frequency bands so that the radio frequency signal coverage scope of base stations would be decreased, the distributed intervals between the base stations would be reduced to avoid the RF signal coverage scope from covering blind spots. Also, because the 5G NR system encompasses the dense mm Wave base stations and the long term evolution (LTE) base stations, complicated ultra dense networks (UDNs) are built. Nonetheless, because the mobile communication device of a client would frequently encounter the signal coverage scope of the base stations within the coverage scope of the UDNs, the mobile communication device of the client would face frequent handover opportunities. The handover mechanism in the prior art merely considers the signal strength between the mobile communication device and each base station, and therefore, if the two values of the signal strength between the mobile communication device and the two base stations are close to each other in a certain region, the mobile communication device is easily switched between the two base stations, and this unnecessary handover mechanism easily results in ping-pong effects.

### SUMMARY

In light of the aforementioned descriptions, the present disclosure provides a determination method of a handover mechanism and a determination system of a handover mechanism to solve the problems generating in the prior art.

In order to achieve the aforementioned objects, the determination method of the handover mechanism provided by the present disclosure is used in a plurality of base stations within a 5G NR network. There is a mobile communication device within the signal common coverage scope of the plurality of base stations, and the mobile communication device builds a communication connection with a first base station in the plurality of base stations. The determination method of the handover mechanism includes: transmitting a plurality of handover parameters to the mobile communication device by the plurality of base stations; calculating the position of the mobile communication device, the moving velocity of the mobile communication device and the signal strength between the mobile communication device and each of the plurality of base stations according to the plurality of handover parameters; determining whether the mobile communication device moves toward a second base station in the plurality of base stations according to the variations of the position; when determining that the mobile communication device moves toward the second base station, according to the moving velocity, obtaining a handover margin threshold value and time to trigger by fuzzy logic calculation; determining whether the signal strength between the mobile communication device and the second base station is greater than the sum of the signal strength between the mobile communication device and the first base station and the handover margin threshold value and whether the hold time when the signal strength between the mobile communication device and the second base station is greater than the sum of the signal strength between the mobile communication device and the first base station and the handover margin threshold value is greater than the time to trigger; when determining that the signal strength between the mobile communication device and the second base station is greater than the sum of the signal strength between the mobile communication device and the first base station and the handover margin threshold value and the hold time when the signal strength between the mobile communication device and the second base station is greater than the sum of the signal strength between the mobile communication device and the first base station and the handover margin threshold value is greater than the time to trigger, switching the communication connection of the mobile communication device from the first base station to the second base station.

In order to achieve the aforementioned objects, the determination system of the handover mechanism provided by the present disclosure is used in a plurality of base stations within a 5G NR network. There is a mobile communication device within the signal common coverage scope of the plurality of base stations, and the mobile communication device builds a communication connection with a first base station in the plurality of base stations. The determination system of the handover mechanism includes a signal transmission module, a calculation module, and a processing module. The signal transmission module is configured to induce the plurality of base stations to transmit a plurality of handover parameters to the mobile communication device. The calculation module is electrically connected to the signal transmission module and is configured to calculate the position of the mobile communication device, the moving velocity of the mobile communication device and the signal strength between the mobile communication device and each of the plurality of base stations according to the plurality of handover parameters. The processing module is electrically connected to the calculation module and performs the following steps: determining whether the mobile communication device moves toward a second base station in the plurality of base stations according to the variations of the position; when determining that the mobile communication device moves toward the second base station, according to the moving velocity, obtaining a handover margin threshold value and time to trigger by fuzzy logic calculation by the calculation module; determining whether the signal strength between the mobile communication device and the second base station is greater than the sum of the signal strength between the mobile communication device and the first base station and the handover margin threshold value and whether the hold time when the signal strength between the mobile communication device and the second base station is greater than the sum of the signal strength between the mobile communication device and the first base station and the handover margin threshold value is greater than the time to trigger; when determining that the signal strength between the mobile communication device and the second base station is greater than the sum of the signal strength between the mobile communication device and the first base station and the handover margin threshold value and the hold time when the signal strength between the mobile communication device and the second base station is greater than the sum of the signal strength between the mobile communication device and the first base station and the handover margin threshold value is greater than the time to trigger, switching the communication connection of the mobile communication device from the first base station to the second base station.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 is a structural schematic diagram of a determination system of a handover mechanism according to one embodiment of the present disclosure.

FIG. 2 is a state schematic diagram of a plurality of base stations and a mobile communication device according to one embodiment of the present disclosure.

FIG. 3 is a flowchart of a determination method of a handover mechanism according to one embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all other embodiments obtained by a person skilled in the art shall fall within the scope of protection of the present disclosure.

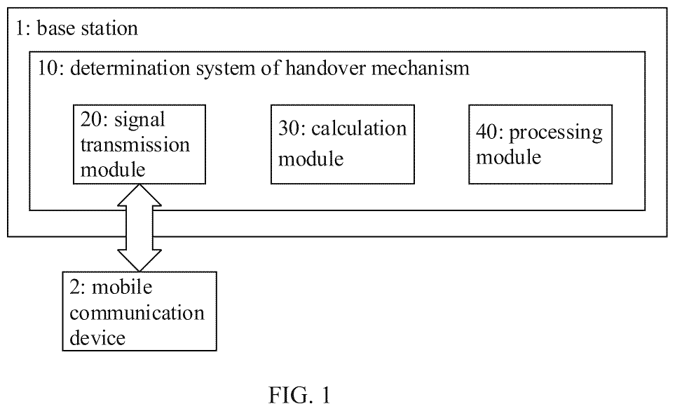

Please refer to FIG. 1, which is a structural schematic diagram of a determination system of a handover mechanism according to one embodiment of the present disclosure.

In one embodiment of the present disclosure, the determination system of the handover mechanism 10 is used in the interior of each of the plurality of base stations 1 to determine whether to induce the mobile communication device 2 to switch the base station 1 connected to thereof. Each of the plurality of base stations 1 is applicable to a 5G NR network and may be a mm Wave base station and an LTE base station, but the present disclosure is not limited thereto and may also extend to the application of the handover mechanism of a low earth orbit satellite (LEOS). The mobile communication device 2 may be a smart phone, a wearable device and so on, and the present disclosure does not limit the type of the mobile communication device 2. The mobile communication device 2 may lie within the signal common coverage scope of the plurality of base stations 1 and build a communication connection with one of the plurality of base stations 1.

The determination system of the handover mechanism 10 includes a signal transmission module 20, a calculation module 30, and a processing module 40, and the signal transmission module 20, the calculation module 30 and the processing module 40 are electrically connected with each other. The signal transmission module 20 is configured to induce the plurality of base stations 1 to transmit a plurality of handover parameters to the mobile communication device 2. The calculation module 30 is electrically connected to the signal transmission module 20 and is configured to calculate the position of the mobile communication device, the moving velocity of the mobile communication device and the signal strength between the mobile communication device and each of the plurality of base stations according to the plurality of handover parameters. In other words, when the mobile communication device 2 moves to the signal common coverage scope of the plurality of base stations 1, the signal transmission module 20 of each of the plurality of base stations 1 transmits a signal to the mobile communication device 2. After receiving the signals from the plurality of base stations 1, the mobile communication device 2 would obtain the received signal strength indication (RSSI) and the signal to interference plus noise ratio (SINR) of the signal transmitted from each of the plurality of base stations 1 to the mobile communication device 2. Afterwards, the mobile communication device 2 returns the aforementioned values of the RSSI and the SINR corresponding to the plurality of base stations 1 to the plurality of base stations 1 after receiving the signals from the plurality of base stations 1, and the calculation modules 30 of the plurality of base stations 1 may also calculate the values of the RSSI and the SINR of the signal transmitted from the mobile communication device 2 to each of the plurality of base stations 1 by the received signals from the mobile communication device 2. Thus, the calculation module 30 of each base station 1 may calculate the position and the moving velocity of the mobile communication device 2 by the signal strength of the signal transmitted from each of the plurality of base stations 1 to the mobile communication device 2 and the known position of each of the plurality of base stations 1. Because the calculation method of the aforementioned position and moving velocity of the mobile communication device 2 and the aforementioned signal strength of the signal transmitted from each base station 1 to the mobile communication device 2 has been known by the person in the art, the calculation method of the aforementioned position and moving velocity of the mobile communication device 2 and the aforementioned signal strength of the signal transmitted from each base station 1 to the mobile communication device 2 is not described herein. The processing module 40 is electrically connected to the calculation module 30 and determines the moving direction of the mobile communication device 2 according to the variations of the position to determine to change the base station 1 connected to the mobile communication device 2.

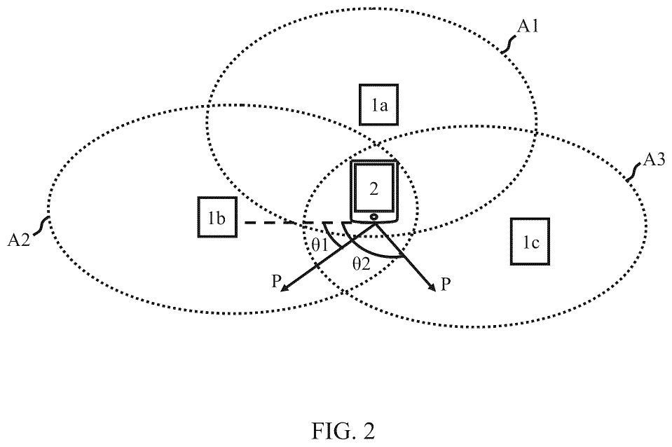

Please refer to FIG. 2 herein, which is a state schematic diagram of a plurality of base stations and a mobile communication device according to one embodiment of the present disclosure.

In one embodiment of the present disclosure, a first base station 1a, a second base station 1b and a third base station 1c respectively have a signal coverage scope A1, A2 and A3 thereof, and the mobile communication device 2 may lie within the signal common coverage scope of the first base station 1a, the second base station 1b and the third base station 1c and build the communication connection with the first base station 1a. When the mobile communication device 2 moves along a first path P1, and the processing module 40 determines that the first offset angle θ1 between the moving direction of the mobile communication device 2 and the second base station 1b is less than 90 degrees, the processing module 40 may determine with certainties whether to perform the handover mechanism between the first base station 1a and the second base station 1b. However, when the mobile communication device 2 moves along a second path P2, the processing module 40 determines that the second offset angle θ2 between the moving direction of the mobile communication device 2 and the second base station 1b is greater than 90 degrees but the offset angle between the moving direction of the mobile communication device 2 and the third base station 1c is less than 90 degrees. So, the processing module 40 may determine not to perform the handover mechanism between the first base station 1a and the second base station 1b and may perform the handover mechanism between the first base station 1a and the third base station 1c.

In addition, the calculation module 30 may further obtain a handover margin (HOM) threshold value and time to trigger (TTT) by fuzzy logic calculation according to the moving velocity. The HOM threshold value is a constant, and the HOM threshold value and the TTT are defined by the A3 event in 3GPP TS 38.331 specification. The A3 event defines: when the signal strength of the second base station 1b adjacent to the mobile communication device 2 is greater than the sum of the signal strength of the first base station 1a serving the mobile communication device 2 at present, a threshold value and an offset value, the handover mechanism would enter the TTT, and only when still remaining the same handover situation after the TTT, the mobile communication device 2 would perform a handover decision strategy, and the sum of the threshold and the offset is the HOM threshold value. Moreover, because the mobile communication device 2 moving at high speed has the smaller HOM threshold value and the shorter TTT in comparison with mobile communication device 2 moving at low speed, the calculation module 30 may utilize the fuzzy logic calculation to set the HOM threshold value as three different values, such as an increase of 10%, an increase of 0% or a decrease of 10%. The setting of the increase of 10%, the increase of 0% or the decrease of 10% may be also performed on the TTT, but the present disclosure is not limited thereto. Thus, the processing module 40 determines whether the signal strength between the mobile communication device 2 and the second base station 1b is greater than the sum of the signal strength between the mobile communication device 2 and the first base station 1a and the handover margin threshold value and whether the hold time when the signal strength between the mobile communication device 2 and the second base station 1b is greater than the sum of the signal strength between the mobile communication device 2 and the first base station 1a and the handover margin threshold value is greater than the TTT to determine whether the communication connection of the mobile communication device 2 is switched from the first base station 1a to the second base station 1b.

In one embodiment of the present disclosure, the signal transmission modules 20 of the first base station 1a, the second base station 1b and the third base station 1c transmit the entire handover parameters to the mobile communication device 2. The calculation module 30 calculates the first offset angle θ1 between the moving direction of the mobile communication device 2 and the second base station 1b, and when the processing module 40 determines that the first offset angle θ1 between the moving direction of the mobile communication device 2 and the second base station 1b is less than 90 degrees, the calculation module 30 calculates the signal strength between the mobile communication device 2 and the first base station 1a and the signal strength between the mobile communication device 2 and the second base station 1b. In one embodiment of the present disclosure, the SINR between the mobile communication device 2 and the first base station 1a and the SINR between the mobile communication device 2 and the second base station 1b may be calculated, and the absolute value of the RSSI of the signal transmitted from the first base station 1a to the mobile communication device 2 and the absolute value of RSSI of the signal transmitted from the second base station 1b to the mobile communication device 2 may be calculated, and they are determined according to the formulas as follows:

SINR(T)>SINR(D1)&SINR(D2)+HOM and

|RSSI(T)|≥|RSSI(D1)|

SINR(D1) is the SINR of the signal from the first base station 1a to the mobile communication device 2, the SINR(D2) is the SINR of the signal from the mobile communication device 2 to the first base station 1a, the SINR(T) is the SINR of the signal from the second base station 1b to the mobile communication device 2, RSSI(T) is the absolute value of RSSI of the signal transmitted from the second base station 1b to the mobile communication device 2, RSSI(D1) is the absolute value of the RSSI of the signal transmitted from the first base station 1a to the mobile communication device 2, and HOM is the HOM threshold value. The processing module 40 determines whether the SINR of the signal from the second base station 1b to the mobile communication device 2 is greater than the sum of the SINR of the signal from the first base station 1a to the mobile communication device 2, the SINR of the signal from the mobile communication device 2 to the first base station 1a and the HOM threshold value, and determines whether the absolute value of RSSI of the signal transmitted from the second base station 1b to the mobile communication device 2 is greater than or equal to the absolute value of the RSSI of the signal transmitted from the first base station 1a to the mobile communication device 2, and regards the foregoing determination as the foundation of determining the value of the signal strength. The processing module 40 may compare the signal strength between the mobile communication device 2 and the second base station 1b with the sum of the signal strength between the mobile communication device 2 and the first base station 1a and the HOM threshold value once per second. Until the signal strength between the mobile communication device 2 and the second base station 1b is greater than the sum of the signal strength between the mobile communication device 2 and the first base station 1a and the handover margin threshold value, and the hold time when the signal strength between the mobile communication device 2 and the second base station 1b is greater than the sum of the signal strength between the mobile communication device 2 and the first base station 1a and the handover margin threshold value is greater than the TTT, the communication connection of the mobile communication device 2 is switched from the first base station 1a to the second base station 1b. It should be noted that although the foregoing two formulas mention the technology of comparing the SINR and the RSSI between each apparatus at the same time, the foregoing two formulas are merely one embodiment of the present disclosure and determining the signal strength between mobile communication device 2 and each base station 1 in the present disclosure is not limited to comparing the SINR and the RSSI between each apparatus at the same time.

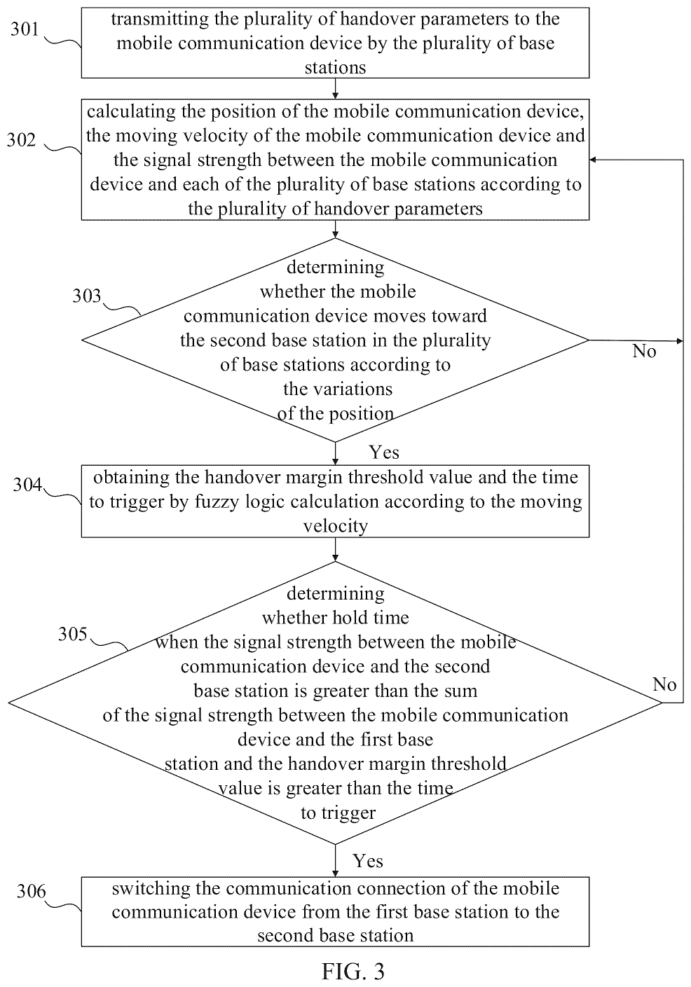

Thereafter, please refer to FIG. 3, which is a flowchart of a determination method of a handover mechanism according to one embodiment of the present disclosure. It should be noted that the determination method of the handover mechanism of the present disclosure is exemplarily explained by the aforementioned determination system of the handover mechanism 10, but the determination method of the handover mechanism of the present disclosure is not limited to using on the determination system of the handover mechanism with the structure same as the determination system of the handover mechanism 10.

First, performing step 301: transmitting a plurality of handover parameters to the mobile communication device 2 by the plurality of base stations 1.

First, because the mobile communication device 2 lies within the signal common coverage scope of the first base station 1a, the second base station 1b and the third base station 1c, the signal transmission module 20 induces the first base station 1a, the second base station 1b and the third base station 1c to transmit the handover parameters to the mobile communication device 2.

Second, performing step 302: calculating the position of the mobile communication device 2, the moving velocity of the mobile communication device 2 and the signal strength between the mobile communication device and each of the plurality of base stations 1 according to the plurality of handover parameters.

After the first base station 1a, the second base station 1b and the third base station 1c transmit the signal to the mobile communication device 2 with each other, the calculation module 30 calculates the position and the moving velocity of the mobile communication device 2 and the signal strength between the mobile communication device and each base station 1 according to the received signals from the first base station 1a, the second base station 1b and the third base station 1c.

Thereafter, performing step 303: determining whether the mobile communication device 2 moves toward the second base station 1b in the plurality of base stations 1 according to the variations of the position.

Because the mobile communication device 2 may stop or be moving, the processing module 40 determines the moving direction of the mobile communication device 2 according to the variations of the position of the mobile communication device 2. Taking the configuration of FIG. 2 as an example, when determining that the first offset angle θ1 between the moving direction of the mobile communication device 2 and the second base station 1b is less than 90 degrees, the processing module 40 may determine that the mobile communication device 2 moves toward the second base station 1b. Moreover, when determining that the first offset angle θ1 between the moving direction of the mobile communication device 2 and the second base station 1b is not less than 90 degrees, the processing module 40 may determine that the mobile communication device 2 does not move toward the second base station 1b and may go back to step S302 to recalculate the position of the mobile communication device 2.

After determining that the mobile communication device 2 moves toward the second base station 1b, the processing module 40 subsequently performs step 304: obtaining the handover margin threshold value and the TTT by the fuzzy logic calculation according to the moving velocity.

Because the mobile communication device 2 moving at high speed has the smaller HOM threshold value and the shorter TTT in comparison with mobile communication device 2 moving at low speed, the calculation module 30 may further obtain the handover margin threshold value and the TTT by the fuzzy logic calculation according to the moving velocity, and for example, the handover margin threshold value and the TTT may be set as the three different values with the increase of 10%, the increase of 0% or the decrease of 10% according to the moving velocity.

Thereafter, performing step 305: determining whether the signal strength between the mobile communication device 2 and the second base station 1b is greater than the sum of the signal strength between the mobile communication device 2 and the first base station 1a and the handover margin threshold value and whether the hold time when the signal strength between the mobile communication device 2 and the second base station 1b is greater than the sum of the signal strength between the mobile communication device 2 and the first base station la and the handover margin threshold value is greater than the TTT.

The calculation module 30 calculates the signal strength between the mobile communication device 2 and the first base station 1a and the signal strength between the mobile communication device 2 and the second base station 1b, and for example, determines the signal strength between the mobile communication device 2 and the first base station 1a and the signal strength between the mobile communication device 2 and the second base station 1b by the formulas as follows: SINR(T)>SINR(D1)&SINR(D2)+HOM and |RSSI(T)|≥|RSSI(D1)|. In one embodiment of the present disclosure, after determining that the signal strength between the mobile communication device 2 and the first base station 1a and the signal strength between the mobile communication device 2 and the second base station 1b conform to the two conditions in the foregoing formulas and the hold time when the signal strength between the mobile communication device 2 and the second base station 1b is greater than the sum of the signal strength between the mobile communication device 2 and the first base station 1a and the handover margin threshold value is greater than the TTT, the processing module 40 performs the handover mechanism. Nonetheless, determining the signal strength between mobile communication device 2 and each base station 1 in the present disclosure is not limited to comparing the SINR and the RSSI between each apparatus at the same time.

So, when the signal strength between the mobile communication device 2 and the first base station 1a and the signal strength between the mobile communication device 2 and the second base station 1b does not conform to the two conditions in the foregoing formulas within the TTT, the processing module 40 may go back to step S303 to redetermine the moving direction of the mobile communication device 2.

When ensuring that the signal strength between the mobile communication device 2 and the first base station 1a and the signal strength between the mobile communication device 2 and the second base station 1b conform to the foregoing formulas, i.e., the signal strength between the mobile communication device 2 and the second base station 1b is greater than the signal strength between the mobile communication device 2 and the first base station 1a, the processing module 40 subsequently performs step S306: switching the communication connection of the mobile communication device 2 from the first base station 1a to the second base station 1b.

After ensuring that the signal strength between the mobile communication device 2 and the second base station 1b has been greater than the signal strength between the mobile communication device 2 and the first base station 1a, the processing module 40 performs the handover mechanism so that the communication connection of the mobile communication device 2 is switched from the first base station 1a to the second base station 1b.

It should be noted that the determination method of the handover mechanism of the present disclosure is not limited to the order of the aforementioned steps and the order of the aforementioned steps may also change as long as the objects of the present disclosure are implemented.

By the aforementioned determination method of the handover mechanism and the determination system of the handover mechanism, the mobile communication device is switched to have the communication connection with a target base station and would not easily perform the handover mechanism after the signal strength between the mobile communication device and each base station is ensured to reduce the generation of ping-pong effects.

It should be noted that the terms “first”, “second”, etc. in the specification and claims of the present disclosure and in the aforementioned accompanying drawings are used to distinguish similar objects and need not be used to describe a particular order or sequence. Furthermore, the terms “comprising” and “having”, and any variation thereof, are intended to encompass a non-exclusive inclusion, for example, a series of steps or units comprising processes, methods, systems, products or equipment need not be limited to those steps or units clearly listed but may include other steps or units not clearly listed or inherent to those processes, methods, products or equipment.

What is claimed is:

1. A determination method of a handover mechanism for a plurality of base stations within a 5G NR network, wherein there is a mobile communication device within a signal common coverage scope of the plurality of base stations, and the mobile communication device builds a communication connection with a first base station in the plurality of base stations, and the determination method of the handover mechanism comprising:
transmitting a plurality of handover parameters to the mobile communication device by the plurality of base stations;
calculating a position of the mobile communication device, a moving velocity of the mobile communication device and signal strength between the mobile communication device and each of the plurality of base stations according to the plurality of handover parameters;
determining whether the mobile communication device moves toward a second base station in the plurality of base stations according to variations of the position;
when determining that the mobile communication device moves toward the second base station, according to the moving velocity, obtaining a handover margin threshold value and time to trigger by fuzzy logic calculation;
determining whether the signal strength between the mobile communication device and the second base station is greater than a sum of the signal strength between the mobile communication device and the first base station and the handover margin threshold value and whether hold time when the signal strength between the mobile communication device and the second base station is greater than the sum of the signal strength between the mobile communication device and the first base station and the handover margin threshold value is greater than the time to trigger;
when determining that the signal strength between the mobile communication device and the second base station is greater than the sum of the signal strength between the mobile communication device and the first base station and the handover margin threshold value, and that the hold time when the signal strength between the mobile communication device and the second base station is greater than the sum of the signal strength between the mobile communication device and the first base station and the handover margin threshold value is greater than the time to trigger, switching the communication connection of the mobile communication device from the first base station to the second base station.

2. The determination method of the handover mechanism according to claim 1, wherein determining whether the signal strength between the mobile communication device and the second base station is greater than the sum of the signal strength between the mobile communication device and the first base station and the handover margin threshold value comprising:
calculating a SINR of a signal transmitted from the mobile communication device to the first base station and a SINR of a signal transmitted from the first base station to the mobile communication device.

3. The determination method of the handover mechanism according to claim 2, wherein determining whether the signal strength between the mobile communication device and the second base station is greater than the sum of the signal strength between the mobile communication device and the first base station and the handover margin threshold value comprising:
determining whether to conform to SINR(T)>SINR(D1)&SINR(D2)+HOM, wherein the SINR(D1) is the SINR of the signal transmitted from the mobile communication device to the first base station, the SINR(D2) is the SINR of the signal transmitted from the first base station to the mobile communication device, the SINR(T) is a SINR of a signal transmitted from the second base station to the mobile communication device, and the HOM is the handover margin threshold value.

4. The determination method of the handover mechanism according to claim 3, wherein determining whether the signal strength between the mobile communication device and the second base station is greater than the sum of the signal strength between the mobile communication device and the first base station and the handover margin threshold value comprising:
calculating an absolute value of RSSI of the signal transmitted from the first base station to the mobile communication device and an absolute value of RSSI of the signal transmitted from the second base station to the mobile communication device.

5. The determination method of the handover mechanism according to claim 4, wherein determining whether the signal strength between the mobile communication device and the second base station is greater than the sum of the signal strength between the mobile communication device and the first base station and the handover margin threshold value comprising:
determining whether to conform to |RSSI(T)|≥|RSSI(D1)|, wherein the RSSI(T) is the RSSI of the signal transmitted from the second base station to the mobile communication device, and the RSSI(D1) is the RSSI of the signal transmitted from the first base station to the mobile communication device.

6. The determination method of the handover mechanism according to claim 1, further comprising:
determining whether an offset angle between a moving direction of the mobile communication device and the second base station is less than 90 degrees;
when determining that the offset angle between a moving direction of the mobile communication device and the second base station is less than 90 degrees, ensuring that the mobile communication device moves toward the second base station.

7. A determination system of a handover mechanism for a plurality of base stations within a 5G NR network, wherein there is a mobile communication device within a signal common coverage scope of the plurality of base stations, and the mobile communication device builds a communication connection with a first base station in the plurality of base stations, and the determination system of the handover mechanism comprising:
a signal transmission module configured to induce the plurality of base stations to transmit a plurality of handover parameters to the mobile communication device;
a calculation module electrically connected to the signal transmission module and configured to calculate a position of the mobile communication device, a moving velocity of the mobile communication device and signal strength between the mobile communication device and each of the plurality of base stations according to the plurality of handover parameters;
a processing module electrically connected to the calculation module and performing the following steps:
determining whether the mobile communication device moves toward a second base station in the plurality of base stations according to variations of the position;
when determining that the mobile communication device moves toward the second base station, according to the moving velocity, obtaining a handover margin threshold value and time to trigger by fuzzy logic calculation by the calculation module;
determining whether the signal strength between the mobile communication device and the second base station is greater than a sum of the signal strength between the mobile communication device and the first base station and the handover margin threshold value and whether hold time when the signal strength between the mobile communication device and the second base station is greater than the sum of the signal strength between the mobile communication device and the first base station and the handover margin threshold value is greater than the time to trigger;
when determining that the signal strength between the mobile communication device and the second base station is greater than the sum of the signal strength between the mobile communication device and the first base station and the handover margin threshold value and the hold time when the signal strength between the mobile communication device and the second base station is greater than the sum of the signal strength between the mobile communication device and the first base station and the handover margin threshold value is greater than the time to trigger, switching the communication connection of the mobile communication device from the first base station to the second base station.

8. The determination system of the handover mechanism according to claim 7, wherein the calculation module calculates a SINR of a signal transmitted from the mobile communication device to the first base station and a SINR of a signal transmitted from the first base station to the mobile communication device.

9. The determination system of the handover mechanism according to claim 8, wherein the processing module further performs the following steps:
determining whether to conform to SINR(T)>SINR(D1)&SINR(D2)+HOM, wherein the SINR(D1) is the SINR of the signal transmitted from the mobile communication device to the first base station, the SINR(D2) is the SINR of the signal transmitted from the first base station to the mobile communication device, the SINR(T) is a SINR of a signal transmitted from the second base station to the mobile communication device, and the HOM is the handover margin threshold value.

10. The determination system of the handover mechanism according to claim 9, wherein the calculation module calculates an absolute value of RSSI of the signal transmitted from the first base station to the mobile communication device and an absolute value of RSSI of the signal transmitted from the second base station to the mobile communication device.

11. The determination system of the handover mechanism according to claim 10, wherein the processing module further performs the following steps:
determining whether to conform to |RSSI(T)|≥|RSSI(D1)|, wherein the RSSI(T) is the RSSI of the signal transmitted from the second base station to the mobile communication device, and the RSSI(D1) is the RSSI of the signal transmitted from the first base station to the mobile communication device.

12. The determination system of the handover mechanism according to claim 7, wherein the processing module further performs the following steps:
determining whether an offset angle between a moving direction of the mobile communication device and the second base station is less than 90 degrees;
when determining that the offset angle between a moving direction of the mobile communication device and the second base station is less than 90 degrees, ensuring that the mobile communication device moves toward the second base station.
